(19) United States
(12) Patent Application Publication
(10) Pub. No.: US 2022/0050479 A1
(43) Pub. Date: Feb. 17, 2022

(54) UAV-BASED PROTECTION FROM ACTIVE SHOOTERS

(71) Applicant: Gneiss Enterprises LLC, Simi Valley, CA (US)

(72) Inventors: Kenneth J. HURST, Simi Valley, CA (US); Tracy HURST, Simi Valley, CA (US)

(21) Appl. No.: 17/399,955

(22) Filed: Aug. 11, 2021

Related U.S. Application Data
(60) Provisional application No. 63/064,848, filed on Aug. 12, 2020.

(51) Int. Cl. G05D 1/12; G05D 1/00; G05D 1/10; H04R 1/40; B64D 47/08; B64C 39/02

(52) U.S. Cl. CPC G05D 1/12; G05D 1/0094; G05D 1/104; H04R 1/406; B64C 2201/127; B64C 39/024; B64C 2201/042; B64C 2201/122; B64D 47/08

(57) ABSTRACT

A system can include one or more unmanned air vehicles (UAVs) that detect a gunshot sound. The one or more UAVs can confirm with each other whether or not a gunshot sound was heard and use shared information to localize the gunshot sound. Other embodiments are described.

### CROSS-REFERENCE TO RELATED APPLICATIONS

This application claims priority to 63/064,848 which was filed on Aug. 12, 2020, the contents of which are incorporated by reference in the present application.

### FIELD

An embodiment of the disclosure relates to a UAV-based system for responding to an active shooter in a variety of settings.

### BACKGROUND

The response to active shooter situations so far has been to deploy law enforcement officers, followed closely by deployment of SWAT members. People have advocated that teachers, administrators, or members of the public be armed with guns to engage in counter-fire with active shooters. Such a response, however, could increase the number of bullets flying around in an area with a high density of innocent bystanders. Solutions can address an active shooter in a faster and safer manner.

### SUMMARY

In some aspects, a system may include a set of UAV aircraft and navigational beacons that are installed in fixtures on the ceiling throughout a venue such as, for example, at a school, hotel, mall, transportation hub, government building, music or sporting event, or other similar venue. The system can optionally include a smaller set of wheeled or tracked robots installed in closets throughout a venue. This set of UAV aircraft (UAVs) can be referred to in the present disclosure as a swarm. The UAVs may be installed outdoors such as on a light fixture, a pole (e.g., utility poles), or other structure that is located above the people. Additional navigation beacons can be installed as needed. When an active shooter is detected, the UAVs may be released from their overhead bases. Each of the UAVs can fly to the vicinity of the shooter and distract, disorient, disable, and/or drive the shooter to a more benign location (such as a location with less bystanders) using non-lethal means.

In some aspects, airborne UAVs and unmanned ground vehicles (UGVs, such as wheeled robots) may communicate with one another during a shooting incident to pinpoint the location of shots and to coordinate a strategy. The UAVs can be equipped with specialized equipment for interacting with the shooter. Each UAV may have navigation sensors, a camera, microphones, a communication channel, and/or a powerful speaker. The UAVs can communicate via the internet with venue headquarters, and with law enforcement that is on the scene and/or at dispatch headquarters. The UGVs may have the ability to open doors or windows as needed to allow the UAVs access. Additionally, or alternatively, doors may be controlled from a central location (such as a school office) and the UAVs may communicate with the door control system to open and close doors as needed.

In some aspects, the UAVs can be triggered autonomously (e.g., without human input) in response to detecting the sound of gunshots or by images of a person entering the area carrying a firearm. If triggered by imagery of someone entering the grounds with a firearm, the swarm can respond, tell the subject to halt (using speakers), and/or wait to take further action. For example, the swarm can wait (e.g., do nothing) until the subject assumes a threatening position. Then the swarm can try to distract, disorient, and/or disable the person. Additionally, or alternatively, the UAVs can also be manually triggered to deploy towards the person. For example, an operator can command the swarm to perform a task such as distract, disorient, and/or disable the person.

An on-site computer logs all communication within or with the system, such as audio, video, inter-UAV data, and commands. This data can be queried by law enforcement and first responders as needed to provide situational awareness and to facilitate post-event documentation.

The UAV response system has objects and advantages. This system allows a response within seconds to an active shooter attack. Studies have found that 70% of the shooting incidents whose duration could be estimated, ended within 5 minutes. Within those, 37% ended within 2 minutes. Further, 60% of the incidents ended before police could arrive. For example, the shooting incident which took place in Santa Clarita, Calif. in 2019 lasted 16 seconds.

Airborne UAVs can fly at high speeds above the heads of people and may be stationed at half a dozen or more locations throughout a venue. They may converge on the scene of the attack from all directions within seconds, guided by localization of the gunshots using the arrival times of the sound of gunfire detected by the various UAVs. The UAVs may communicate to each other their position, the time of arrival that a gunshot is detected, the direction of each gunshot, and/or the loudness of the sound. With such information being shared, the UAVs can quickly pinpoint the gunfire location(s). Indoor and/or outdoor locations can be covered by the UAV system. The response may be non-lethal in nature, and designed to distract, disorient, disarm, possibly disable, and/or drive the attacker into a benign location without putting bystanders in mortal danger.

The UAV system can provide an effective response to an active shooter that operates in the background, allowing a psychologically positive atmosphere, rather than one based on fear, vigilance, training, and preparation for a traumatic event. The UAVs can be housed inconspicuously and can remain dormant until needed. Such a system may be modular and portable, so that it can be deployed temporarily for special events. The system can operate in situations of reduced visibility brought on by for example low or no light, smoke, or fog.

The UAV can be equipped with different tactical features. In some embodiments, the UAV system can communicate wirelessly (e.g., over the internet) with venue officials and with law enforcement, allowing a real-time assessment of the situation even prior to entry that would not be possible with any other means. In some embodiments, the system may mark and follow a perpetrator even in the event that the perpetrator attempts to blend in with the crowd. In some embodiments, the swarm of UAVs can autonomously employ a variety of non-lethal tactics, depending on the installed capabilities. These potential capabilities may include but are not limited to: loud, disorienting noise; very bright and intense light beams or strobes; two-way audio and one-way video to communicate with the perpetrator, either autonomously, or from an official person via the internet; or two-way audio and one-way video to communicate with bystanders. In some embodiments, a UAV may attach itself to a firearm, such as with a strong magnet, a mechanical claw, and/or grasping device. If the shooter is attempting to shoot a firearm, the UAV can exert force on the firearm, spoiling the aim toward a more benign direction. For example, the UAV could exert upward or downward force causing the bullets to hit the ceiling or the ground. In some embodiments, after attaching itself to a gun, a UAV may dispense adhesive onto and/or into the action of the gun, causing it to jam and become inoperable. Urethane foams could be used effectively for such an application. Other adhesives may also be used effectively. In some embodiments, the UAV may include a taser or taser-like device to incapacitate the shooter. Additionally, or alternatively, the UAV can include a pepper spray that may be projected to the shooter via paintball-like pepper pellets, a stream, a spray, or a powder. Additionally, or alternatively, the UAV can include a tranquilizer to incapacitate the shooter. Additionally, or alternatively, the UAV can include a fishnet spread and dropped over the shooter. Additionally, or alternatively, the UAV can include a rope that is wound around the shooter. Additionally, or alternatively, the UAV can include a bat that is swung from the bottom of the airborne UAV. Additionally, or alternatively, the UAV may perform rapid aggressive flying around and near the shooter. As such, the UAV may employ one or more distracting activities while law enforcement officers advance on the shooter. In some embodiments, a UAV may project marking dye on the shooter. Marking dye may help officials recognize the individual even if that individual attempts to blend in with the crowd. The UAV can have a paintball gun or a sprayer that shoots the marking dye. A smelly substance may be included with the dye to make it more difficult for the shooter to hide or to blend in with a crowd.

In some embodiments, a UAV may follow a shooter if the shooter attempts to escape or move to another location. 15% active shooter instances have involved multiple locations. The UAVs may follow a shooter after leaving the first location, keeping law enforcement updated as to the location of the UAVs and, in turn, the shooter. In some embodiments, the UAV may attach itself to a vehicle in which the shooter is attempting a getaway to conserve the UAV's battery.

In some embodiments, the UAV may turn on a fire-suppression sprinkler system in a location of a building that shooting activity is detected, should a fire-suppression system exist at that location.

The shooter may attempt to knock or shoot the UAVs out of the air, which can distract the shooter to give people time to scatter, and time for responders to arrive. The UAVs may be programmed to fly avoidance maneuvers that make them difficult to hit.

The UAVs may “herd” the shooter into a more favorable location—for example into an unused room where the doors can be locked, or into a place where law enforcement can capture or neutralize the shooter.

In some embodiments, authorized officials can direct the swarm of swarm UAVs to use any of the various tactics available. By selecting different capabilities and assigning these capabilities to different UAVs at the time the swarm of UAVs is installed, a designer may build a swarm with many capabilities that may be tailored to a particular location or venue type. Authorized officials may have the ability to communicate to the swarm to stand down at any time.

By swapping UAVs out and replacing them with UAVs of a different capability, an installation of the UAVs can be evolved to either meet new perceived threats and vulnerabilities, or to simply upgrade the installation through an affordable piecemeal approach.

Further objects and advantages of the system are described in the drawings and ensuing description.

The above summary does not include an exhaustive list of all embodiments of the present disclosure. It is contemplated that the disclosure includes all systems and methods that can be practiced from all suitable combinations of the various embodiments summarized above, as well as those disclosed in the Detailed Description below and particularly pointed out in the Claims section. Such combinations may have particular advantages not specifically recited in the above summary.

### DESCRIPTION OF DRAWINGS

Several embodiments of the disclosure here are illustrated by way of example and not by way of limitation in the figures of the accompanying drawings in which like references indicate similar elements. It should be noted that references to “an” or “one” embodiment in this disclosure are not necessarily to the same embodiment, and they mean at least one. Also, in the interest of conciseness and reducing the total number of figures, a given figure may be used to illustrate the features of more than one embodiment of the disclosure, and not all elements in the figure may be required for a given embodiment.

FIG. 1 shows a block diagram of an example UAV, according to some embodiments.

FIG. 2 illustrates an example scenario of a UAV deployment, according to some embodiments.

FIG. 3 shows a method performed by a UAV, according to some embodiments.

FIG. 4 shows an example workflow of a UAV system, according to some embodiments.

FIG. 5 shows an example workflow of a UAV system with a central information hub, according to some embodiments.

FIG. 6 shows a method of determining the gunshot location based on time differences at different UAVs, according to some embodiments.

FIG. 7 shows a method of determining the direction toward the source of a gunshot from a microphone array of a single UAV, according to some embodiments.

FIG. 8 shows an example of a UAV docking station, according to some embodiments.

FIG. 9 shows an example of a UAV with a UAV dock interface, according to some embodiments.

FIGS. 10A-10D shows an example of a centering cone for a UAV docking stations, according to some embodiments.

FIG. 11 shows an example of a UAV dock interface mated with a centering cone of a UAV docking station, according to some embodiments.

FIG. 12 shows a UAV with a tactical unit, according to some embodiments.

### DETAILED DESCRIPTION

Several embodiments of the disclosure with reference to the appended drawings are now explained. Whenever the shapes, relative positions and other embodiments of the parts described are not explicitly defined, the scope of the invention is not limited only to the parts shown, which are meant merely for the purpose of illustration. Also, while numerous details are set forth, it is understood that some embodiments of the disclosure may be practiced without these details. In other instances, well-known structures, and techniques have not been shown in detail so as not to obscure the understanding of this description.

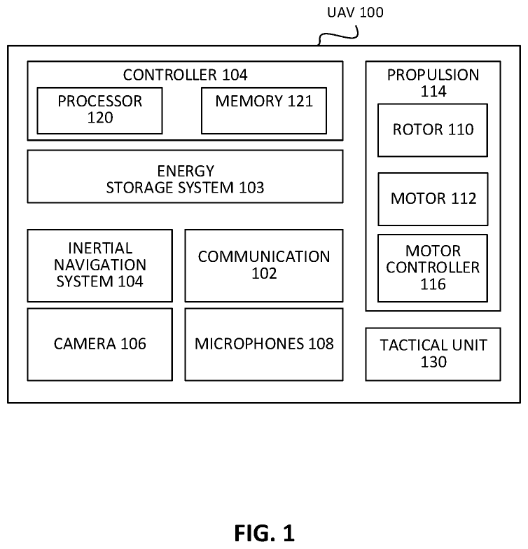

FIG. 1 shows a block diagram of an example UAV 100, according to some embodiments. It should be understood that, for sake of clarity and brevity, not all UAV components are shown in this or other examples, and that those components that are described may include additional features that are not mentioned.

A UAV can include a plurality of microphones 108 that are arranged within or on a surface of the UAV, such that each microphone can sense sounds present around the UAV. The plurality of microphones can form a microphone array with fixed positions that are known to the UAV. In some embodiments, the microphones 108 can form a three-dimensional microphone array, which can be understood as having microphones in at least two planes, rather than in one plane, or in a single line. In some embodiments, microphones 108 include four microphones. With such microphones, a UAV may detect a gunshot sound in microphone signals. The UAV may determine a direction and/or location of the gunshot sound, based on the microphone signals, as discussed in other sections.

In some embodiments, some or all of a swarm of UAVs can have an array of microphones, such as, for example, two microphones, three microphones, four microphones, or more. In some embodiments, a UAV can have exactly four microphones. The microphones can be used for determining the direction of nearby gunshots and, in some embodiments, for communication with the shooter or bystanders.

The UAV can include a controller 104. The controller 104 can perform any of the operations discussed herein. The controller can include a processor 120 that perform instructions stored in computer-readable memory 121. Computer-readable memory may include volatile and/or non-volatile memory. The instructions can embody any of the operations performed by the UAV described herein. As such, the controller can be configured to perform operations through execution of instructions by the processor. Further, it should be understood that processor 120 can include one or more processors, and that memory 121 can include one or more computer-readable memory units. In some cases, each of a plurality of processors can perform dedicated operations that are grouped based on functionality (e.g., communications, audio processing, image processing, navigation, motor controller, executive functionality, tactical responses, etc.). How such functionality is grouped between software components and hardware components in what can collectively be understood as system architecture can vary without departing from the scope of the present disclosure. In the present disclosure, when it is discussed that a UAV performs an operation, this can be understood to mean that the controller of the UAV is performing the operation. This also holds for a controller of a UAV docking station.

UAV 100 can include an energy storage system 103 which can include, for example, one or more battery cells. In some examples, the battery cells can include a lithium-ion based battery cell. In some examples, the battery cells can be re-chargeable. The battery cells can be organized into one or more battery packs. The energy storage system can include one or more electronics circuits that manage the charge and discharge of the battery cells, in what can be referred to as a battery management system (BMS). The electronics circuits can include voltage monitoring, current monitoring, and/or temperature sensing of the battery cells. The energy storage system can power the UAV including the components described in FIG. 1 (for example, the propulsion system, the controller, etc.) as well as other components of the UAV that may not be shown.

The UAV can include a communication unit 102. The communication unit can include a transmitter and receiver, which can be referred to collectively as a transceiver. In some examples, a UAV can include a plurality of transceivers. The UAV can communicate over communication unit 102 to other UAVs, or to other network-connected devices. The communication unit 102 can communicate over wireless communication channels such as, for example, Wi-Fi, LTE, 3G, 4G, 5G, or other wireless communication channels. In some examples, the UAV can communicate to a communication hub that can direct messages between UAVs and ground stations (e.g., a police headquarters or local police unit). The messages can be stored and accessible through the communication hub.

In some embodiments, the UAV can include a camera 106. The camera may be operated by the UAV autonomously or controlled manually by an authorized operator. The controller may apply one or more computer vision algorithms to a camera feed, which can include using a trained artificial neural network to detect a shooter in a camera image. For example, the computer vision algorithm can detect features such as a person's stance, movements, detection of a weapon, etc. and determine a confidence score that indicates whether or not a shooter is present in the images. When recognized, the images can be used for further localization of the shooter, which be used, for example, to aim the UAV or other tactical device at the shooter. Various computer vision algorithms can be employed by the UAV.

The UAV can include a tactical unit 130 which can include one or more tactical devices described in the present disclosure, such as, for example, a fluid dispenser, a pellet gun, a grasper, a noise generator or loudspeaker, a display, a light, a magnet, or other tactical device.

The UAV can include an inertial navigation system 104. The internal navigation system can include an accelerometer and/or gyroscope. The controller may use the internal navigation system to perform dead reckoning to navigate the UAV to the location or in the direction of the gunshot sound. For example, dead reckoning may include calculating current position of the UAV by using a previously determined position of the UAV, and then incorporating estimations of speed, heading direction, and course over elapsed time. Sensed or derived information from the inertial navigation system such as speed, direction and course can be calculated from the acceleration and direction provided by the accelerometer and/or gyroscope.

In some embodiments, an initial position of the UAV can be fixed based on the position of the UAV's docking station relative to a known environment (e.g., a venue) in which the UAV system is installed. Further, the UAV may include map data of the environment. The UAV can perform the dead reckoning with reference to the map data to determine and update the location of the UAV relative to the map data. The UAV can periodically determine the current location of the UAV in the environment based on the previously determined location of the UAV and the sensed information from the inertial navigation system 104. The UAV can determine the direction or location of the gunshot based on the microphone signals. In such a manner, the UAV can navigate to the location or the direction of the gunshot sound using dead reckoning.

UAV 100 may include a propulsion system 114 that can be operated by controller 104 to hover, move forward, move backward, move side to side, rise, or descend. The propulsion system can include one or more rotors 110. Each rotor can include a propeller blade which can be spun by a respective motor 112. A motor can be a bi-directional motor that can spin clockwise and counterclockwise, on command. Controller 104 can generate a series of control commands that command the plurality of rotors in a coordinated manner to hover, move forward, move backward, turn, move side to side, rise, or descend the UAV. For example, a motor controller 116 may receive digital commands and convert them to motor control commands for each of the motors. Sensors can sense direction and speed of each motor, which can be used as feedback by the motor controller 116 and/or controller 104 to adjust the motor speed.

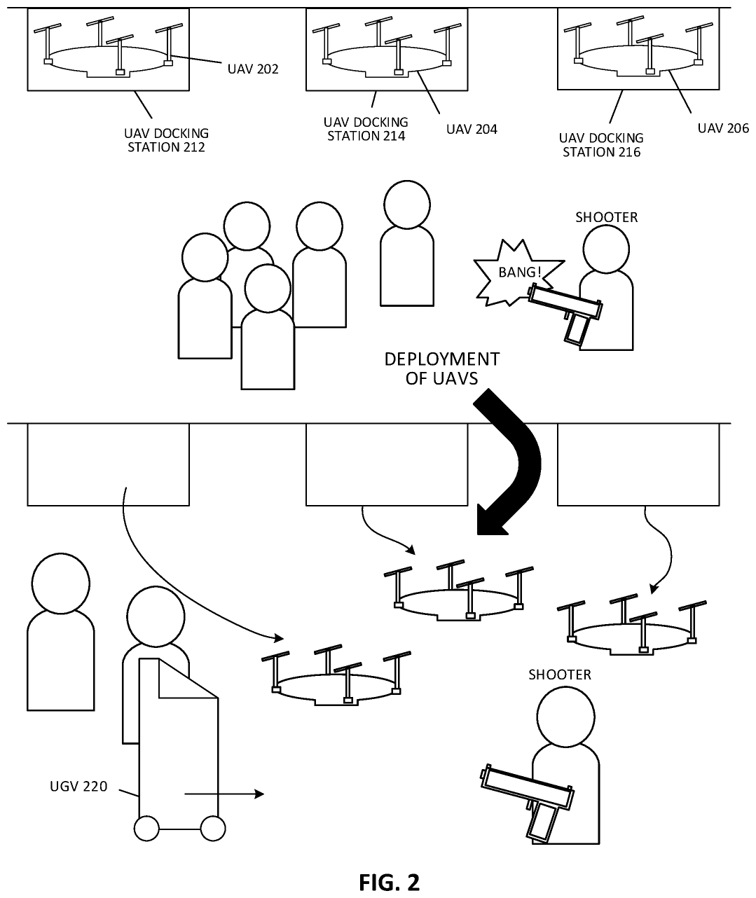

FIG. 2 illustrates an example scenario of a UAV deployment, according to some embodiments. One or more UAVs (202, 204, 206) may be housed in UAV docking stations (212, 214, 216). Each UAV docking station can include a housing that encloses the UAV. The docking stations can be bolted to the ceiling of a venue, attached to a pole, or otherwise fixed to an overhead position. The UAV may be held in place within the enclosure by a UAV dock that can be located within the UAV docking station. The UAV dock can mate with a UAV docking interface of the UAV.

In some embodiments, the UAV dock can include a UAV controllable coupler (e.g., a latching mechanism) that holds a stem that is fixed to the UAV. The stem can be guided by a cup-cone configuration as described in some sections. The UAV can have electrodes which can be fixed to the UAV or stem. The UAV can, therefore, charge its batteries when the UAV is held in the UAV docking station. There are various ways to hold the UAVs in a docking station. The UAVs may be kept in a charged state in their enclosures, and maintain active communication with a central hub and with each other.

Any of the docking stations 212, 214, 216 can include openings and/or a porous housing that allows sound to freely pass from outside of the docking station to inside of the docking station to allow a UAV to detect a gunshot.

The docking stations 212, 214, 216 can visually cover the UAVs so that the presence of the UAVs is less obvious, and to provide protection of the UAVs from being vandalized (e.g., thrown objects). The UAVs can monitor their respective microphone signals and communicate with each other to confirm whether a gunshot is heard and/or to share when the gun shot is heard at each UAV for localizing the gunshot.

In response to detecting a gunshot, and/or confirming the gunshot sound is heard by other UAVs, each of the UAVs (202, 204, 206) can deploy from their respective docking stations (212, 214, 216) and navigate to the location of the gunshot. While navigating to the gun shot sound, the UAVs may communicate with each other their respective locations, whether or not subsequent gun shots are detected and from what direction. Each UAV can timestamp when each gunshot sound is detected. The timestamp can be communicated and shared between the UAVs to together locate the gun shot sound.

In some embodiments the system may also include wheeled or tracked robots 220 (e.g., UGVs). These robots can be installed in closets and have the ability to open and close doors (e.g., with one or more appendages that can be robotically actuated with various degrees of freedom) and exert larger forces than capable by a UAV. The UAVs can communicate to the UGVs via a network to coordinate movement towards the gun shot. In some embodiments, a UAV can command a UGV to deploy and open a door or window that is in the path between the UAV and the gun shot sound.

In some embodiments, wheeled or tracked robots could be activated to travel to the scene of the attack. Since these robots are ground-based, they may face heavy pedestrian traffic. As such, these robots may not be able to move as quickly or as freely as the airborne UAVs. These ground-based robots may be used in coordination with the UAVs in a variety of manner such as to aid in crowd control, to open or close doors as necessary, and/or offering another line of counter-attack against an active shooter.

Additionally, or alternatively, a central hub may issue commands to door actuators to open and close doors remotely. Doors of a venue can have remote-controlled actuators that can open or close a door. A UAV could communicate with the central hub (e.g., over a wireless communication channel) to open or close a door for the UAV to navigate. In some embodiments, the UAVs can communicate with the UAV to strategically control the door states to help direct pedestrian traffic isolate from the shooter, or to trap the shooter. In some embodiments, a UAV can use its speaker to request bystanders to help with opening a door if necessary. Additionally, or alternatively, UAV pass-throughs (e.g., dedicated openings in walls) may be installed above the doors of a facility that a UAV could navigate through to reach enclosed areas (e.g., a room or a building) in a venue.

Upon arrival at the scene, the UAVs may detect a shooter based on comparison of video images from the scene with images of shooters with guns, and by continuous localization of any shots that are fired. The UAV may use a trained neural network or other computer vision algorithm to detect the shooter. Once detected, the swarm of UAVs may fly to the shooter from all possible directions, and execute non-lethal tactics to distract, disorient, disarm, possibly disable, and/or drive the shooter to a more benign location. Given that the UAVs may operate autonomously for the first few minutes or longer, and because many bystanders are presumed to be present, only non-lethal measures may be permitted under autonomous conditions. When law enforcement officers arrive on scene and decide to do so, they may employ UAVs with other capabilities, some of which could be lethal. This system can, in some embodiments, deploy lethal response as well, although for the reasons given above autonomous lethal responses can be avoided in favor of non-lethal responses. A panoply of tactics can be employed by the swarm which may be determined by the mix of capabilities of individual UAVs at the time the system is installed.

Each of the UAVs can also include a speaker for communication with the shooter or bystanders and also for disorienting and distracting the shooter, a streaming camera for informing outside forces of the situation and also possibly for on-board situational awareness, an inertial navigation package, other collision avoidance and situational awareness sensors as needed, a WIFI internet connection, and at least one other capability (e.g., for disabling or creating a nuisance to a potential shooter).

Each UAV can include a microphone array having a plurality of microphones in fixed and known positions on or within the UAV. Each UAV can process microphone signals generated from each of the microphones to detect one or more gunshot sounds. If the UAV detects a possible gunshot, the UAV can communicate with the other UAVs that the gunshot has been detected. The UAV can also communicate the UAV's position, the exact time it sensed the shot (for example, within 1.0 msec of when the gunshot was sensed), and the direction toward the source of the gunshot sound.

The location of the gunshots can be determined from the gunshot sounds using one or more techniques. In some embodiments, each UAV can determine, from its own array of microphones, the direction toward the source. By flying along the vector toward the source, the UAV can eventually reach the source. Reflections and hallways could initially cause a mistaken vector for a single shot, however following this vector will still result in tracing the sound ray path back to the source if there are continuing shots. In some embodiments, the intersection of the directions determined by two UAVs can provide an estimate of the shot location, so long as the location is not on the direct line between the stations.

In some embodiments, the UAV system may monitor a camera feed and be activated by images of someone entering the premises with a firearm. The images may be generated by one or more cameras present on the UAVs, on the housings, and/or cameras arranged in the venue/environment. If triggered by imagery of someone entering the grounds with a firearm, the UAV swarm can respond, tell the suspect to stop, and wait to take further action until the subject assumes a threatening position or an authorized person instructs the system to stand down. As discussed, the system could also be triggered manually by an authorized user. For example, the authorized user can communicate to one or more of the UAVs over a wireless communication channel such as Wi-Fi, LTE, 3G, 4G, 5G, or other wireless communication channel.

In some embodiments, the system can be trained to recognize either law enforcement uniforms or individual law enforcement officers so as to avoid triggering when such individuals enter while in possession of a firearm. For example, one or more of the UAVs may apply a computer vision algorithm to camera images taken by the UAV. The computer vision algorithm can detect presence of a person in the image, and whether or not a person is a law enforcement agent, such as by searching for features that could indicate a police uniform or other characteristic of a law enforcement agent.

In some embodiments, each UAV may include an inertial navigation unit which it uses in combination with a pre-programed map of the venue to navigate through the venue with reference to its current location within the venue. Additionally, or alternatively, the UAV can perform localization using a local Wi-Fi network, GPS, and/or video imagery to constantly update its position.

In some embodiments, the UAVs may have a communication link with law enforcement. Through the communication link, the UAVs can set off an alarm notifying law enforcement when the UAVs have deployed. The UAVs can also provide real-time situational awareness over the communication link. This may include a 3-D environment and stereo audio using 3-D headsets in communication with one or more of the UAVs. Such features can allow law enforcement to direct a high level strategy and tactics of the UAV swarm in a human-machine collaboration. Further, the swarm can help law enforcement by enhancing situational awareness and by distracting the shooter(s) as the officers move in.

In some embodiments, swarm activities may be coordinated with outside activities such as, for example, nearby officers, activation of a SWAT team, activation of medical services, activation of psychological resources, scrambling a helicopter, or other activity. This is may be accomplished through a communication link to law enforcement headquarters that can be re-routed when appropriate to a local incident command center. When law enforcement arrives at the scene or venue, the UAVs may identify them as law enforcement rather than a shooter. In some embodiments, the UAVs can herd the shooter into an area where law enforcement can be more effective, or distract the shooter while law enforcement moves in.

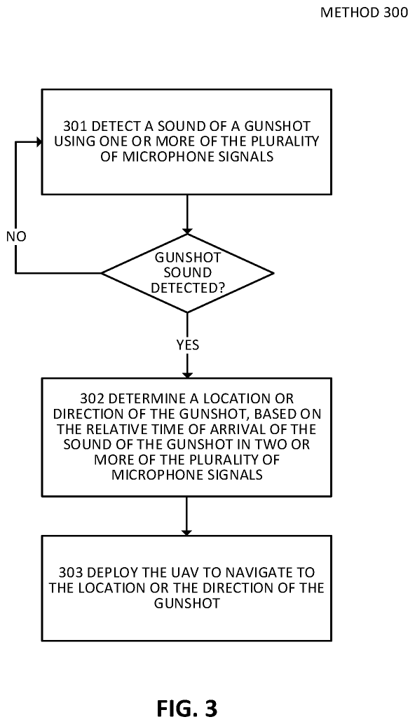

FIG. 3 shows a method 300 performed by a UAV, according to some embodiments. The operations of the method can be performed by a UAV or a controller of the UAV such as controller 104.

At block 301, the controller can detect a sound of a gunshot using one or more of the plurality of microphone signals. The controller can process the microphone signals to detect whether the microphone signals include an audio signature that resembles a gunshot sound. An audio signature can include loudness and/or changes in loudness per sub-band over time. The controller can analyze the signature to determine whether or not the signature satisfies criteria. The criteria can include an envelope of loudness and/or changes in loudness per sub-band that are associated with a gunshot sound. Further, different firearms may have varying unique signatures. Thus, the criteria may include different criteria for different firearms. As such, the controller can compare the signature of the microphone signals with the criteria to determine if the signature falls within any of the criteria. In response to the signature falling with criteria, the controller can deem that a gunshot has been detected. In some embodiments, a machine learning algorithm (e.g., a trained neural network) can be applied to the microphone signals to detect presence of a gunshot.

At block 302, in response to the sound of the gunshot being detected, the controller can determine a location or direction of the gunshot, based on the relative time of arrival of the sound of the gunshot in two or more of the plurality of microphone signals. For example, based on the relative time of arrival of the gunshot sound, the controller can determine the direction that the gunshot sound relative to the UAV. Further, a UAV can communicate to and receive from the other UAVs when each gunshot sound is detected and the location of the UAV. From this pooled information, the UAV can determine the location of the gun shot sound, which can be relative to the mapped environment of the UAVs. If no gunshot sound is detected, the UAV may continue to rest in the UAV docking station where it can charge its energy storage system and monitor the microphone signals for presence of a gunshot sound.

At block 303, the controller can deploy the UAV to navigate to the location or the direction of the gunshot. For example, the controller can open a door of a UAV docking station in which the UAV is housed in. The controller can release the UAV from a held position in the UAV docking station. The controller can send a series of commands to the propulsion system that moves the UAV in the direction or the location of the gunshot.

In some embodiments, the UAV can proceed to blocks 302 and 303 in response to when it confirms with one or more other UAVs that the gunshot sound is detected. For example, a UAV may communicate, through a transceiver of the UAV, with a second UAV that the sound of the gunshot is detected. The UAV can receive a communication from the second UAV over the transceiver that confirms that the sound of the gunshot is also detected by the second UAV. In response to the confirmation, the UAV and/or the second UAV can navigate to the location or the direction of the gunshot. The communication from the second UAV can include information that is used by the UAV to determine the location of the gunshot, for example, the location of the second UAV and/or the timestamp of when the gunshot sound was detected by the second UAV.

In some embodiments, a gunshot sound may be detected by another UAV. That other UAV may communicate this to the UAV. In response, the UAV that receives this communication may deploy and navigate to direction or location of the gun shot sound, even if that UAV does not detect a gunshot sound. In some embodiments, if more than one UAV hears a gunshot sound, and then all UAVs can deploy to the gunshot sound.

In some embodiments, the UAV can receive a message from the third UAV that a gunshot is detected, which can prompt the UAV to check whether or not the gunshot is present in the microphone signals of the UAV. The UAV can then confirm with the third UAV whether or not the gunshot was detected by the UAV. For example, a UAV can receive a communication from a third UAV through a transceiver of the UAV, the communication indicating that the third UAV has identified the gunshot. In response to receiving the communication from the third UAV, the UAV can detect whether the sound of the gunshot is present within the plurality of microphone signals of the UAV, and communicate to the third UAV, through the transceiver, whether the gunshot is detected by the UAV. The communication from the third UAV to the UAV can include a location or a direction of the gunshot as detected by the third UAV, and the communication from the UAV to the third UAV can include a location or a direction of the gunshot as detected by the UAV.

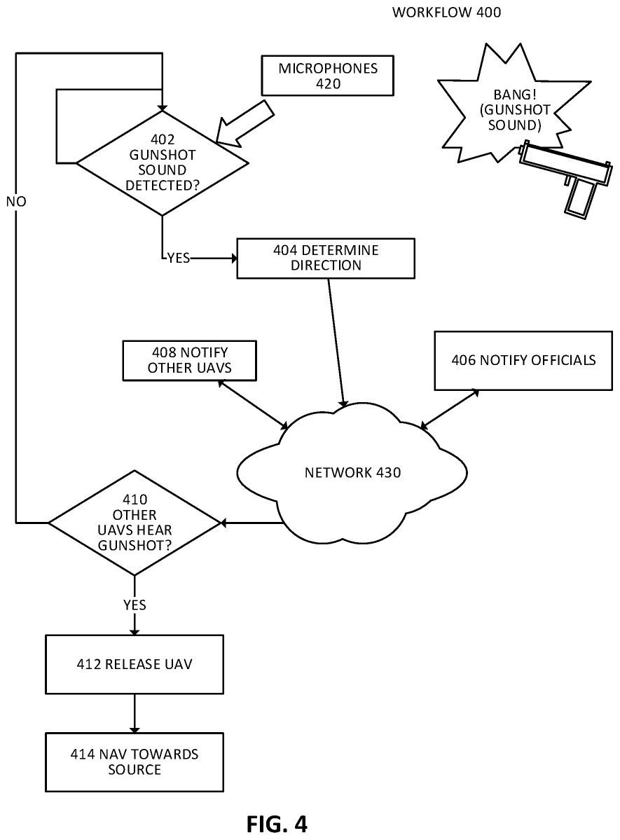

FIG. 4 shows an example workflow 400 of a UAV system, according to some embodiments. The workflow can be performed by one or more UAVs through their respective controllers.

At block 402, a UAV can monitor microphone signals 420 to detect whether or not a gunshot sound is detected. The microphone signals can be generated from the microphones of the UAV. In response to detecting a gunshot sound, the UAV can proceed to block 404 to determine a direction of the gunshot sound.

At block 404, the UAV can determine a direction of the gunshot sound based on the gun shot sound as detected in the microphone signals. This can be performed based on arrival time of the gunshots at different microphones, as described in other sections.

The UAV may communicate with other UAVs and/or to other computing devices (e.g., a central hub, a police headquarter, etc.) that are communicatively coupled to network 430. For example, in some embodiments, at block 406, the UAV can notify officials that a gunshot has been detected. The UAV can transmit a message over a communication channel to a network connected device that is monitored by officials. The message can include the time when the gunshot was detected, a location of the UAV, whether the UAV is deployed and navigating to the gunshot sound, and/or other information.

At block 408, the UAV can notify other UAVs that a gunshot sound has been detected. The UAV can transmit a message over a communication channel to other UAVs that are installed in the shared environment (e.g., a building, stadium, campus, park, etc.), where the message can include the time when the gunshot was detected, a location of the UAV, and/or other information. It should also be understood that, at this block, the UAV may also receive messages from the other UAVs that are installed in the shared environment that includes the same information but from the perspective of each of the other UAVs. From this information, the UAV can derive a location of the gunshot in the environment.

At block 410, the UAV can determine if other UAVs also detected a gunshot. For example, the other UAVs can communicate with the UAV over a network 430. Each of the other UAVs can indicate in a message whether or not a gunshot sound was detected. At block 412, in response to one or more of the other UAVs also detecting a gunshot, the UAV can cause itself to release from a UAV docking station.

At block 414, the UAV can navigate to the gunshot source. The UAV can follow a direction or a location of the gunshot sound, which can be used with other navigational features. In some examples, the UAV may use a preinstalled internal map of the venue and several on-board sensors to navigate to the shooter. The UAV may include collision avoidance sensors such as, for example, ultrasonic, radar and/or a camera). Computer vision algorithms can be applied to the sensor data to recognize objects such as walls, people, landmarks, etc. The UAV may include navigation software that enables the UAV to avoid obstacles that may or may not have moved since the internal map was initially made. Navigation relative to the internal map may be accomplished through landmark matching with the on-board cameras and on-board inertial navigation units. The sounds from multiple shots may be used to refine the location of the shooter as the UAV closes in. At any time, law enforcement or other authorized users can command the UAV to stand down which will cause it to land safely. In some embodiments, the navigate to shooter block 414 can end when the UAV is within a threshold distance of the shooter (e.g., 30 feet, 20 feet, or less) and/or the location of the shots are visible from the UAV location.

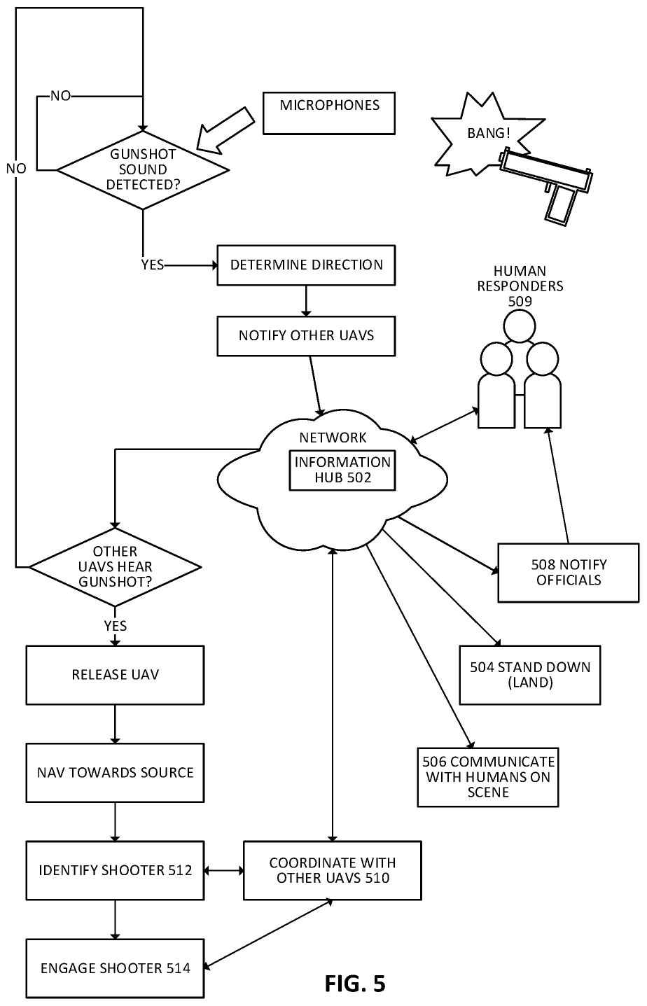

FIG. 5 shows an example workflow of a UAV system with a central information hub, according to some embodiments. The UAV can perform operations as described with reference to FIG. 4, with some additions. For example, at block 508, the UAV can notify officials that a gunshot has been detected. The UAV can share information with officials such as a direction or location of the gunshot sound, when it was detected, and more. Human responders 509 such as police officers, SWAT team, fire fighters, and/or other human responders may arrive at the scene. The UAV can communicate those messages with the human responders 509 to equip them with knowledge as to where the shooter may be or when the shooter was last active.

At block 504, the UAV may stand down, such as land or fly back to their respective docking stations. This can be performed in response to a command from one of the human responders or an authorized user (e.g., a controller at a police station). At block 506, the UAV can communicate with humans at the scene. The humans can be pedestrians or venue goers that may need instruction or reassurance due to the shooting incident. As such, the UAV may facilitate a one-way communication (e.g., via speakers and/or a display) or a two-way communication (e.g., via speakers and/or a display and the microphone system) with the humans on the scene. In a one-way communication, the UAV may play audio that gives instructions or reassurance that first responders are on the way. In some embodiments, a remote user can speak to the humans on the scene through the UAV. This can be a one-way communication (e.g., through speakers and/or a display of the UAV) or a two-way communication (e.g., through speakers and/or a display and the microphones of the UAV). In some embodiments, a camera of the UAV may take pictures or a live video feed of the scene, which can include the shooter or other scenes of interest. The images or video feed can be sent through the network to a display (e.g., through an information hub that is accessible by law enforcement).

In some embodiments, the UAV can coordinate with other UAVs 510, such as by sharing detected gunshot timestamp, direction of gunshot or location of the gunshot with reference to a shared internal map. Further, UAVs can identify a shooter with one or more camera images (e.g., through computer vision). Such information can be shared between the UAVs. For example, a first UAV can indicate to the rest of the UAVs that a shooter has been detected based on camera images of the first UAV. The first UAV can also share images of the shooter with the other UAVs so that the other UAVs can also identify the shooter more easily.

At block 514, the UAVs can pool the audio-based localization information and/or the visual-based localization information to determine how to engage the shooter. For example, based on a visual identification of the shooter at block 512, one or more of the UAVs can recognize the shooter in one or more live camera images (e.g., a feed). The UAV can perform one or more tactics towards the shooter, using the live camera feed for aim. The tactics can be non-lethal.

Further, each of the communications over the network, such as between the UAVs, between a UAV and human responders, notifications to officials, actions taken by each UAV (e.g., gunshot sound heard, deployment, tactics, etc.), and other communications can be managed, routed, or logged through a central hub 502. For example, the information hub can route messages between UAVs, store messages to electronic memory, and route communications between the UAV and one or more parties such as a first responder or a police headquarter.

In some embodiments, the UAVs can also be deployed manually from the central hub, and told of a location to navigate to. In the case of manual activation, the central hub can present an interactive map to one or more users that allows a user to specify the location for the UAVs to navigate to.

In such a manner, the central information hub 502 may provide information via the internet and Wi-Fi to law enforcement headquarters, on-scene law enforcement officers, on-scene, medical personnel facility, administration and other first responders. It may also archive all audio, video and other data taken by the system. In some embodiments, the central information hub can be accessible and controllable through a graphical user interface, which can be presented through a web page or computer application. The information hub can be accessible to users through a mobile computing device, laptop computer, or other computing device.

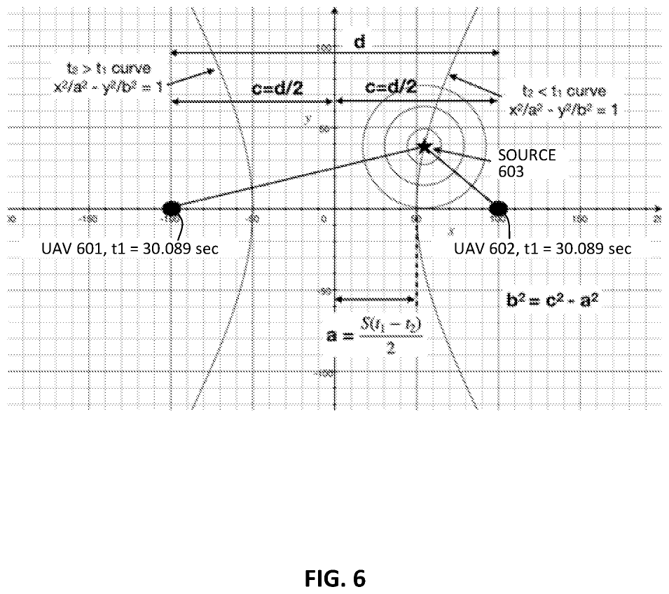

FIG. 6 shows a method of determining the gunshot location based on time differences at different UAVs, according to some embodiments. Each UAV can calculate the location of a gunshot based on the arrival times of the gunshot sound as detected by at least two other UAVs and the locations of those UAVs. The UAVs can apply a long range navigation (LORAN) technique to locate the gunshot. The difference in time between the arrival of the gun shot sound at two UAVs can be due to one of the UAVs being closer to the sound source than the other UAV. Each of the UAVs can multiply the time difference with the speed of sound to determine how much closer one of the UAVs is than the other.

For example, if the gun shot location originates exactly in the middle between two UAVs so that it is exactly the same distance from both UAVs, then the time difference will be zero. This, however, would not typically be the case. A curve traced out by all the possible shot locations based on one-time difference between two stations can be a hyperbola with foci at the two stations. Given two other UAVs, three hyperbolas can be drawn based on the three time differences between pairs of stations. The intersection of the hyperbolas can be taken to yield the location of the source of the gun shot. To permit determination of the time differences, the clocks of the UAVs may be synchronized, for example to 10 msec or less. In some examples, if the UAV can receive GPS signals, then the UAVs can synchronize by each taking time from GPS. If the UAV cannot receive GPS signals, which may be likely for the majority of indoor installations, then a standard internet protocol for time sync may be used such as Reference Broadcast Synchronization, Timing-sync Protocol for Sensor Networks, or Flooding Time Synchronization Protocol. In some embodiments, clock synchronization can be performed while the UAV is docking, but these clocks would be synchronized once deployed. Once the UAV is deployed, its own local clock may maintain time to within 10 msec over the maximum deployment time of 20 minutes. This level of stability is within the capability of Temperature Compensated Crystal Oscillators (TCXO).

For example, in FIG. 6, a UAV (e.g., 601 or 602) can calculate the location of a gunshot based on the difference in time the gunshot sound is received at the UAV 601 and the second UAV 602, and the direction toward the gunshot. As discussed, the difference in the time the gunshot sound is received at each UAV can be used to define a hyperbola. The equation for a hyperbola can be expressed as x²/a²−y²/b²=1. In this example the time difference is 30.089−30.000=0.089 seconds. This difference, multiplied with the speed of sound gives us the parameter ‘a’ in the equation above. Taking the speed of sound as S=1125 ft/sec, a UAV can obtain, in this example, a=0.089*1125/2=50. The parameter ‘b’ is calculated by noting that b1=c1−a1 where c=d/2 and d is the distance between the two UAVs. In this example d is 200 feet, and so b=86. 6. Since each UAV also determines the direction to the gunshot from its own array of microphones, each UAV can determine the location as the intersection of the direction vector and the hyperbola. A UAV can also calculate the location based on the intersection of the two vectors from the two UAVs, however doing so may result in large uncertainties for gunshots near the line joining the two UAVs.

The topology of the venue or environment (for example long hallways, and many walls) in which the UAVs are deployed can make the immediate determination of the source location more difficult due to echoes and guiding of the sound waves down long halls. With multiple UAV installations spaced around the venue, however, the echoes and effects of halls can be overcome. As part of the installation, calibration sounds may be set off at several locations around the venue and their known location can be compared with the on-board solutions for accuracy. The calibration sounds may also be used to ensure that the system can discriminate between, for example, hammering and a gunshot at that venue. In some embodiments, UAV installations may be spaced apart in an environment/venue creating a network of coverage. A UAV installation can be understood as the installation of the UAV housings, the UAVs within the housings, and infrastructure such as navigational beacons, electrical power, network communications, and more. A UAV according to the present disclosure may reduce false triggers of a gunshot sound better than some audio based gunshot detection systems. The UAV system according to the present disclosure may have each UAV strategically located in a venue such that they form a listening network. Such a UAV system aims to be on scene with the suspected attacker in under 10 seconds. This can be accomplished where each UAV and UAV docking station is installed strategically around the venue so that a distance between a gunshot and the nearest UAV docking station (with UAV housed within) is less than 300 feet, or in some embodiments, 200 feet or less. Each installation of a UAV system to a venue can be tuned by firing calibration shots with a variety of weapons during off hours, as well as hammering, and other sounds that are not gunfire but which might be mistaken for gunfire. The locations of each UAV and UAV docking station, as well as parameters of the UAV system can be tuned during calibration to reduce false triggers and to tune the time that it takes for a UAV to arrive at a given location in response to a gunshot (e.g., so that the UAV arrives in under 10 seconds).

Given that an important goal of an installation is to have a UAV be deployable at the gun shot location within a few seconds (e.g., under 10 seconds), the spacing between UAV housings can, in some embodiments, range from 120 to 280 feet. In some embodiments, the spacing ranges from 160 to 240 feet. In some embodiments, the spacing is 200 feet or roughly so. In some embodiments, the UAV housings are spaced at 1 per acre, or roughly so. Given this spacing, localization of the source of the gunshot by the system can be determined as discussed, in a straight forward manner.

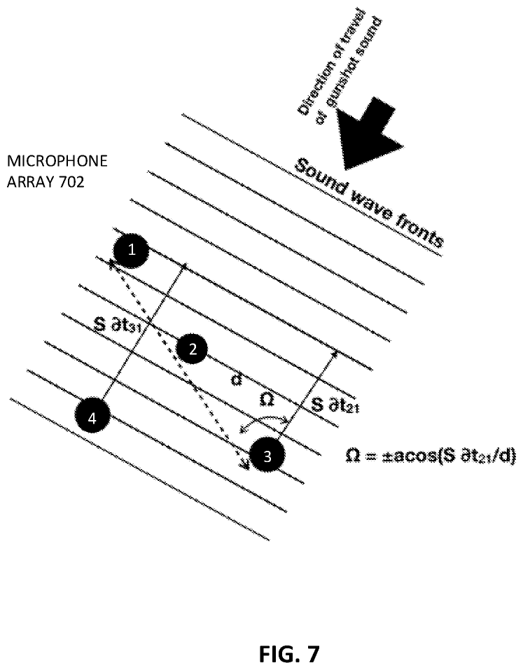

FIG. 7 shows a method of determining the direction toward the source of a gunshot from a microphone array of a single UAV, according to some embodiments. A UAV may have a microphone array 702 that includes two or more microphones. In some embodiments, microphone array 702 includes four microphones (shown as 1, 2, 3, 4). Three of the microphones (1, 2, 3) may be have fixed positions in a common horizontal plane. The fourth microphone (4) may have a fixed position above or below the common horizontal plane.

The distance between microphones 1 and 2 is shown here as d. A UAV can measure a difference in time between when microphone 1 senses the gunshot shot, to when microphone 2 senses the gunshot (=δt21) and multiplying by the speed of sound (1125 ft/sec) yields the length of the vector labeled S δt21. The direction toward the shot Q relative to the vector d can be determined as ±δ cos (S δt21/d). The UAV can use the time difference δt31 to discriminate between the +δ cos (S δt21/d) and the −δ cos(Sδt21/d) solutions. This 2D example may be implemented in 3D using an array of microphones (e.g., having four microphones) on a single UAV. In such a manner, a UAV can determine a direction of a gunshot sound.

In some embodiments, relative amplitudes or a sound pressure level (SPL) of a sound such as a gunshot can be sensed at each UAV and used (e.g., in addition to other techniques) to help with localizing a sound source based on known techniques using relative loudness. For example, if the gunshot sound is measurably louder in one microphone and less loud in another microphone, the UAV may infer that the microphone with the louder gunshot sound is closer to the gun shot location.

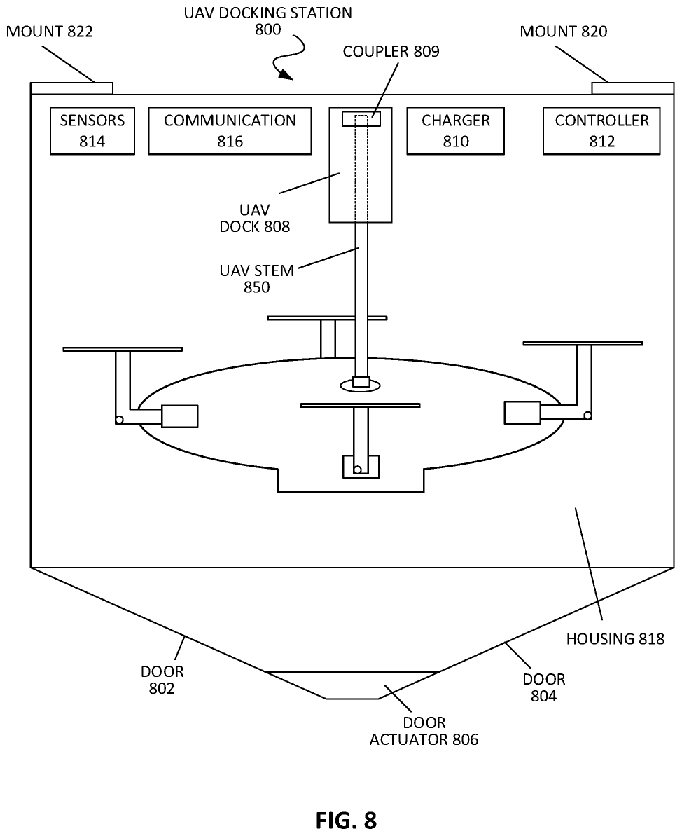

FIG. 8 shows an example of a UAV docking station 800, according to some embodiments. The UAV docking station can include a housing 818 with one or more walls that visually conceals the UAV from view outside of the housing. The docking station can include a UAV controllable actuator 806 that can be commanded by the UAV to open the housing in response to a command from the UAV, such that the UAV can exit the docking station.

For example, the actuator 806 can be controlled to turn an electromagnetic force on or off. When the electromagnetic force is off, one or more doors (e.g., doors 802, 804) are held by a permanent magnetic force. When the electromagnet is on, it repels the permanent magnet, and the doors can fall open. In some embodiments, the actuator 806 can be fixed to a door such as door 802. In some embodiments, the docking station includes four doors, each triangular in shape, that come together when closed to form a downward facing pyramid. When the magnetic actuator is released, the four doors can swing open with the actuator being attached to one of the four doors. Additionally, or alternatively, the door actuator 806 can include a controllable latch that holds the one or more doors closed and is mechanically coupled to an actuator. The actuator can be commanded to a release position, which, in turn, causes one or more doors of the UAV docking station to open.

A UAV dock 808 can include one or more holding and guiding members to hold and guide a UAV stem 850 into a fixed position on the UAV dock 808. As described in other sections, the UAV dock can include a cone shaped receptacle that can serve as a guiding member. The receptacle can have a first opening that tapers into a smaller second opening for the UAV to mechanically couple with.

Such a cone with alignment mechanism promotes that the UAV is consistently deployed from a known position and orientation. Further, such a mechanism also promotes servicing of the UAV. The UAV may release from the dock and land in a designated location for servicing. When the servicing is done, the UAV can fly back into the housing and the dock. As such, ladders and lifts may not be needed for most maintenance and inspections.

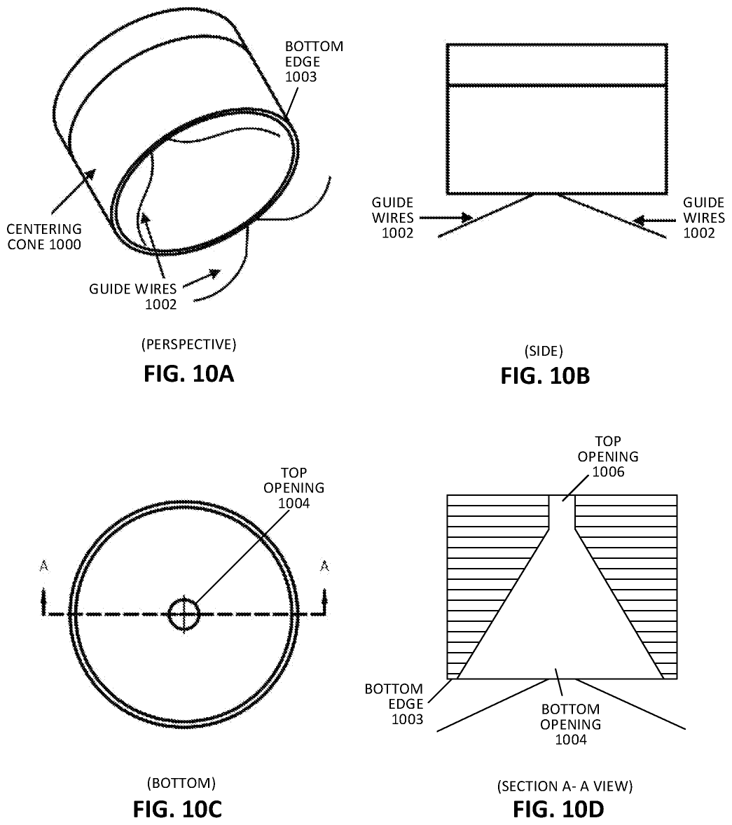

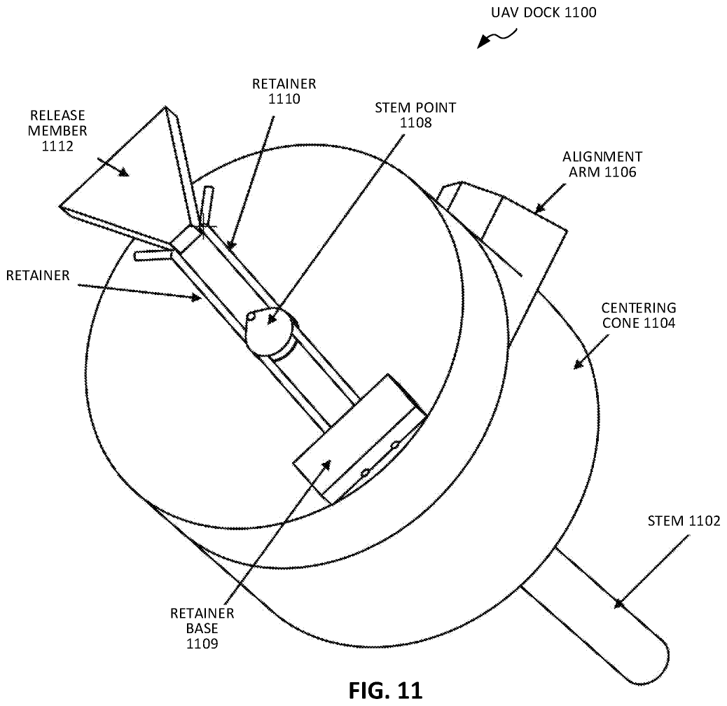

In some embodiments, the UAV dock 808 includes a notch for an alignment arm attached to the UAV to slide into and mate with, as shown, for example, in FIG. 11. In other embodiments, the dock 808 can include guide wires that are located outside of the cone shaped opening, as shown for example, in FIGS. 10A-D. A UAV controllable coupler 809 holds and releases the UAV on command of the UAV, an example of which is shown as including a release member 1112 and retainer 1110 in FIG. 11. The coupler 809 can include various arrangements of one or more latching members that are coupled to an actuator, where the actuator is controlled by the UAV.

The UAV may have a docking interface which can include the UAV stem 850 that mates with the UAV dock 808 of the UAV docking station. In some embodiments, the docking interface of the UAV may include electrical contacts for charging the UAV's batteries. In some embodiments, the UAV may include electrical contacts for energizing the door actuator 806, and/or energizing the release of the coupler 809.

A charger 810 can include an electronics circuit (e.g., power switching semi-conductors, charge controllers, voltage and current sensors, etc.) that is configured to charge a battery pack of the UAV. The UAV docking station can include a controller 812 that can include one or more processors and computer-readable memory. A communication unit 816 can include a transceiver, which can be communicatively coupled to a wireless network. In some embodiments, the communication unit can communicate with the UAV through a wireless or wired communication channel. In some embodiments, the UAV may issue one or more commands to the UAV docking station through the communication channel, such as, for example, a ‘release’ command. The UAV docking station can include one or more sensors 814 such as a camera and/or one or more microphones that generate images or one or more microphone signals, which can be communicated to the UAV.

The UAV housing 818 can be formed from a polymer, metal, or other suitably strong and durable material. In some embodiments, one or more openings in the housing allow for sound to pass from outside to within the housing, so that the UAV microphones can pick up a gunshot sound. In some embodiments, the UAV housing 818 can include a fabric region for sound to pass through, which can be stretched on a frame or similar construction. The UAV housing walls can be transparent to sound so that the UAVs are able to effectively monitor for gunshot sounds.

The UAV docking station can include one or more mounts (e.g., 820, 822) that can attach the UAV docking station to a ceiling, a pole, or other structure that can be elevated over people.

In some embodiments, when the UAV detects a shot the UAV can deploy, which includes releasing itself from the housing. The UAV can operate a door release actuator of the housing that opens a door of the housing. The UAV can then activate a UAV release actuator that releases the UAV from the UAV dock such that the UAV falls down from the UAV housing. While falling, the UAV can commence flying to the scene of the attack.

In some embodiments, the door release actuator can include magnetic latches that hold one or more doors of the UAV housing closed until the UAV activates the door release actuator to open. In some embodiments, the UAV release actuator can include a solenoid-actuated opening wedge. The wedge can be driven by the actuator to split the dual-wire spring catch. One example of such as system is shown, for example, in FIG. 11. Other systems and methods of releasing the UAVs can be implemented.

Once activated and released from the dock in the ceiling (or other convenient location), each UAV immediately may fly as fast as possible to the scene of the attack as determined by localization of the gunshot sound. As discussed, localization of the gunshot sound can be determined based on comparing the time of arrival of the gunshot sounds and the direction to the shots at the location of each UAV. Additionally, or alternatively, the UAVs can deploy and fly to a specified location given to the UAVs by officials, in what can be referred to as a manual deployment. As the UAV gets close to the scene, the UAV can triangulate the direction to additional gunshots from its own microphone array, and/or can recognize a shooter based on camera images taken by use of artificial intelligence (e.g., a trained artificial neural network) and/or known computer vision techniques that can be trained to recognize shooting stances.

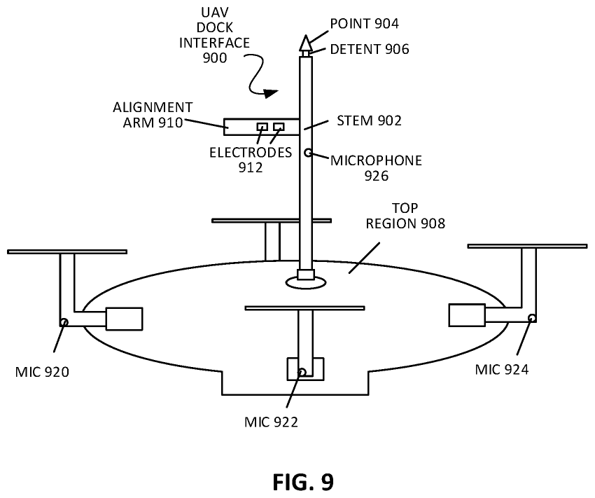

FIG. 9 shows an example of a UAV with a UAV dock interface 900, according to some embodiments. A UAV such as those described in other sections can have a UAV dock interface 900 that mechanically couples to a UAV dock of a UAV docking station. The UAV dock interface 900 can include a stem 902 that can be attached to the UAV at a top region 908 of the UAV. The stem can point up and away from the UAV, so that the UAV can fly into and drop out of the UAV dock. Gravity may help reduce the deployment time of the UAV.

The stem can include a point 904 at the tip of the stem. The stem can also include a detent 906 which can be below the point. The UAV can fly up into a cone shaped guide of the UAV dock and then become held in place at the detents by a latching arm, wires, or other holding members of the UAV dock, as described in other sections.

An alignment arm 910 can be fixed to the stem. In some embodiments, when the UAV dock interface is mated with the UAV dock, the alignment arm can fit into a notch of the UAV dock. In some embodiments, the alignment arm can fit between guide wires of the UAV dock. The alignment arm can have electrodes 912 that can include a positive electrode and a negative/return electrode. These electrodes can physically and electrically connect with terminals of the UAV dock when the UAV dock interface 900 is mated with the UAV dock. The electrodes 912 may be internally routed to an energy storage system of the UAV to charge a battery pack.

On the UAV, a plurality of microphones 920, 922, 924, and 926 can form a microphone array with fixed and known positions. In some embodiments, three of the microphones (920, 922, and 924) may be fixed to respective locations of the UAV such that they are in a common horizontal plane with respect to the UAV. The fourth of the microphones 926 can be fixed to a portion of the stem. As such, the four microphones may form a three dimensional microphone array, which can help the UAV determine a direction of a sound.

FIGS. 10A, 10B, 10C, and 10D show an example of a centering cone for a UAV dock, according to some embodiments. A centering cone 1000 can be part of the UAV dock that is integrated and fixed within a UAV docking station. The centering cone can have a bottom opening 1004 that is formed by a ring-shaped bottom edge 1003 that tapers into a top rear opening 1006 as shown in the sectional view of FIG. 10D. In such a manner, the centering cone can guide a tip of the UAV's docking interface into the top opening 1006. On the UAV docking station, a latch, wires, hook, or other holding member that is not shown here can hold the UAV's docking interface where it passes beyond the top opening of the UAV dock. The centering cone can include one or more pairs of guide wires 1002. Each pair of guide wires can include a first wire and a second wire that each protrudes from the bottom edge 1003 of the centering cone. The first wire and the second wires can be angled such that they guide an alignment arm (as described in other sections) to move towards the space between the first wire and the second wire when the UAV dock interface mates with the UAV dock.

In some embodiments, as shown in this example, the centering cone can include two pairs of guide wires. One pair can be located on a first side of the centering cone, and the second pair can be located on a second side of the centering cone that is opposite of the first side. The guide wires can come in contact with one or more alignment arms of the UAV docking interface. As such, the guide wires can help guide the UAV docking interface towards the center of the cone. In some embodiments, the guide wires can include a positive terminal and a negative/return terminal that are internally connected to a battery charger within the UAV docking station. As such, the docking station can charge the UAV when the UAV rests in the docking station.

FIG. 11 shows an example of a UAV dock interface mated with a UAV dock, according to some embodiments. The UAV dock 1100 can include a centering cone 1104 that has a front opening into which the stem 1102 of the UAV docking interface inserts into during docking. The front opening can taper into a top opening so that the stem is guided into the smaller top opening. A retainer 1110 can hold the stem when it pushes past the top opening of the centering cone. A release member 1112 can be actuated by the UAV to release the retainer.

In some examples, the UAV dock 1100 can include a retainer base 1109 that holds two wires that form the retainer 1110. Each of the wires can have a spring force that pushes toward a space between the two wires. The stem can have a stem point 1108 that, when pushed past the top opening, also pushes between the two wires. The spring loaded wires of the retainer can arrange themselves into a detent of the stem, thus holding the stem and the UAV in place. The UAV can cause the retainer to release the stem by actuating the release member 1112 which can have a shape of a wedge. The release member can include an actuator that drives the wedge between the wired retainer 1110 which forces the wired retainer apart and out of the detent, thereby releasing the stem from the centering cone. Pulled by gravity, the UAV can drop out of and away from the centering cone, in a downward direction.

In some examples, an alignment arm 1106 may be fixed to the stem 1102. The alignment arm can also have a wedge, triangle, or D shape with two sloping sides that come towards each other to guide the stem into position in the centering cone. In some aspects, the alignment arm can have electrodes (a positive and a negative/return) that mate with electric terminals of the UAV dock, as described in other sections. In some embodiments, each electrode can be positioned at a respective one of the sloping sides. The alignment arm can fit into a notch such that, when mated, the electrodes are in physical and electrical connection with the terminals of the UAV dock. In other examples, the alignment arm can push into guide wires of the centering cone, examples of which are shown in FIGS. 10A, 10B, 10C, and 10D. Although some examples are shown, a UAV can mechanically and electrically dock into the UAV docking station in more ways without departing from the scope of the disclosure.

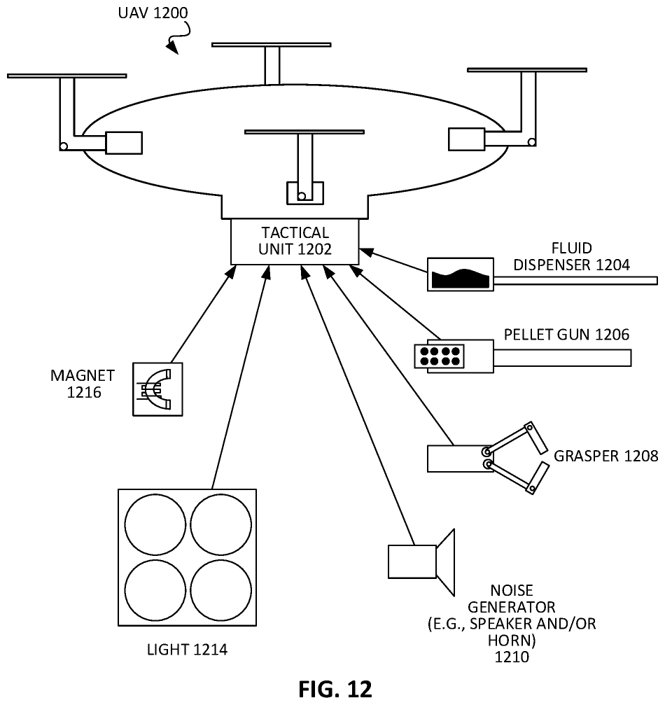

FIG. 12 shows a UAV 1200 with a tactical unit 1202, according to some embodiments. In some embodiments, the UAV 1200 can include one or more tactical units. In some embodiments, the UAV includes at least one tactical unit. The tactical unit can include a fluid dispenser 1204, a pellet gun 1206, a noise generator 1210, a display 1212, a light 1214, or a magnet 1214. The UAV controller can detect a shooter by using computer vision to process images output by a camera, and apply one or more of the tactics using the image feed and computer vision for aiming towards the detected shooter. For example, the UAV controller can use a fluid dispenser 1204 which can spray or squirt a fluid such as a paint or marking dye, a glue, or an irritant such as a pepper spray. The fluid can be scented or pungent to make identification of the shooter easier and to distract the shooter. In some examples, a pellet gun 1206 can fire fluid-filled pellets at the detected shooter. The fluid can include those mentioned with the fluid dispenser 1204.

The tactical unit can include a grasper 1204 which can include one or more robotic fingers or a wire loop. The grasper can grab and hold onto the shooter to distract and hamper the shooter's movement. Further, in some embodiments, the UAV can include the fluid dispenser and a grasper. The UAV can grasp onto the shooter's arm, weapon, or shooting hand and dispense a glue on the firearm thereby disabling the firearm.

In some embodiments, the tactical unit includes a noise generator 1210 such as a speaker and/or a horn. The noise generator can cause a powerful sound that can distract or irritate the shooter. The microphone and speaker can facilitate one-way or two-way communication with the shooter. Law enforcement, first responders, or other trained professionals can communicate with the shooter directly and in real-time. In some embodiments, the tactical unit includes a light 1214 that can be activated. The light can be operated for visibility as well as to blind a shooter, by shining into the shooter's eyes. In some embodiments, the tactical unit includes a magnet 1216 which can be activated or deactivated upon command by the UAV. The magnet can attach itself to the firearm thereby making the firearm hard to or impossible to use. In some embodiments, the UAV includes both the magnet and the dispenser. The UAV can include other combinations of the tactics as well as tactics not shown in this figure.

Non-limiting embodiments of the disclosure include:

1. An unmanned air vehicle (UAV) comprising:

a plurality of microphones, each of the microphones generating a respective microphone signal; and

a controller having one or more processors, configured to perform operations, the operations including:

detecting a gunshot sound using one or more of the plurality of microphone signals,

in response to the gunshot sound being detected,

determining a location or direction of the gunshot sound, based on two or more of the plurality of microphone signals, and

deploying the UAV to navigate to the location or the direction of the gunshot sound.

2. The UAV of embodiment 1, wherein the operations include communicating, through a transceiver of the UAV, with a second UAV that the gunshot sound is detected, and

deploying the UAV to navigate to the location or direction of the gunshot sound only if a communication from the second UAV is received over the transceiver that confirms that the gunshot sound is also detected by the second UAV.

3. The UAV of embodiment 2, wherein the communication from the second UAV provides information that is sufficient to determine the location of the gunshot.

4. The UAV of embodiment 2, wherein communicating with the second UAV includes a time stamp of when the gunshot sound was sensed by the microphones of the UAV and the location of the UAV.

5. The UAV of embodiment 4, wherein the UAV and the second UAV each have a clock that are synchronized with each other.

6. The UAV of embodiment 2, wherein the communication between the UAV and the second UAV is performed over at least one of the following: Wi-Fi, Bluetooth, ZigBee, 2G, 3G, 4G, 5G, or DigiMesh.

7. The UAV of any of one embodiments 1-6, further comprising an inertial navigation system including an accelerometer and gyroscope, wherein the operations include performing dead reckoning using data from the accelerometer and gyroscope to navigate the UAV to the location or in the direction of the gunshot sound.

8. The UAV of embodiment 7, wherein map data of an environment of the UAV is stored in local UAV memory that is communicatively coupled to the controller, or stored remotely and accessible to the controller through wireless communication, and the dead reckoning is performed with reference to the map data to determine and update the location of the UAV relative to the map data, to navigate to the location or the direction of the gunshot sound.

9. The UAV of embodiment 7, further comprising a Wi-Fi receiver or GPS receiver, wherein the operations include using Wi-Fi access points or GPS data to navigate to the location or the direction of the gunshot sound.

10. The UAV of embodiment 7, further comprising a camera that generates image data, wherein the operations include recognizing structures in the image data to navigate the UAV to the location or the direction of the gunshot sound.

11. The UAV of any one of embodiments 1-10, further comprising a camera that generates image data, wherein the operations include using computer vision to process the image data to identify a shooter or a firearm in the image data.

12. The UAV of any one of embodiments 1-11, further comprising one or more speakers, wherein the operations include broadcasting a live audio feed or an audio recording to a UAV environment through the one or more speakers.

13. The UAV of any one of embodiments 1-12, further comprising a plurality of rotors, each rotor having a motor and a propeller, wherein deploying the UAV includes generating a series of control commands that command the plurality of rotors in a coordinated manner to hover, move forward, move backward, turn, move side to side, rise, or descend.

14. The UAV of any one of embodiments 1-13, wherein the operations include receiving a communication from a third UAV through a transceiver of the UAV, the communication indicating that the third UAV has identified a second gunshot sound, in response to receiving the communication from the third UAV, detecting whether the second gunshot sound is present within the plurality of microphone signals of the UAV, and communicating to the third UAV, through the transceiver, an indication of whether the second gunshot is detected.

15. The UAV of embodiment 14, wherein the communication from the third UAV to the UAV includes an indication of a location or a direction of the second gunshot sound, and the communication from the UAV to the third UAV includes an indication of whether a location or a direction of the second gunshot sound as detected by the UAV.

16. The UAV of any one of embodiments 1-15, wherein the operations include in response to receiving, through a transceiver of the UAV, a communication from a user that includes an instruction to navigate to a user specified location, navigating the UAV to the user specified location.

17. The UAV of any one of embodiments 1-16, wherein determining the direction of the gunshot sound includes calculating the direction of the gunshot sound based on relative arrival times of the gunshot sound in at least three of the UAV's microphone signals.

18. The UAV of any one of embodiments 1-17, wherein the operations further include calculating a direction of subsequent gunshot sounds using the microphone signals, and navigating the UAV toward the location or the direction of the subsequent gunshot sounds.

19. The UAV of any one of embodiments 1-18, wherein the plurality of microphones is four microphones.

20. The UAV of any one of embodiments 1-19, wherein the plurality of microphones are arranged at fixed and known positions upon the UAV, forming a 3 dimensional microphone array.

21. The UAV of any one embodiments 1-20, further comprising a camera; and

a paintball gun, wherein the operations include detecting a shooter by using computer vision to process images output by the camera, and commanding the paintball gun to fire a paintball pellet at the detected shooter.

22. The UAV of embodiment 21, wherein the paintball pellet contains at least one of: a paint, a pungent scented material, a pungent scented paint, a pungent scented marking dye, a pungent scented pepper spray liquid.

23. The UAV of embodiment 21, wherein the computer vision includes recognizing human poses that are associated with a suspected shooter.

24. The UAV of embodiment 21, further comprising a camera; and

a noise generator or a bright light, wherein the operations include detecting a shooter by using computer vision to process images output by the camera, and activating the noise generator or the bright light when within a threshold proximity to the detected shooter.

25. The UAV of any one of embodiments 1-24, further comprising a camera; and

a magnet or grasper, wherein the operations include detecting a shooter by using computer vision to process images output by the camera, and navigating the UAV to attach the UAV to the detected firearm through the magnet or the grasper.

26. The UAV of embodiment 25, further comprising and adhesive dispenser; and

the operations include commanding the adhesive dispenser to dispense an adhesive onto the firearm or into an action of the firearm, upon being attached to the firearm.

27. The UAV of any one of embodiments 1-26, further comprising an adhesive dispenser; and

the operations include commanding the adhesive dispenser to dispense an adhesive onto the firearm or into an action of the firearm, upon being attached to the firearm.

28. The UAV of any one of embodiment 26 or embodiment 27, wherein the adhesive includes polyurethane foam.

29. The UAV of any one of embodiments 1-28, further comprising at least one of: a taser, a tranquilizer, a net gun, a rope, or a bat, being operable by the controller.

30. The UAV of any of embodiments 1-29, wherein the operations include communicating, through a transceiver of the UAV, with a second UAV that the gunshot sound is detected, and

deploying the UAV to navigate to the location or the direction of the gunshot sound only if a communication from the second UAV is received over the transceiver that confirms that the gunshot sound is also detected by the second UAV, wherein a controller of the second UAV is configured to navigate the second UAV to the location or the direction of the gunshot sound, in response to the second UAV also detecting the gunshot sound in microphone signals of a plurality of microphones of the second UAV.

31. The UAV of any of one embodiments 1-30, wherein the UAV rests in a docking station prior to deployment and deploying the UAV to navigate to the location of the gunshot sound includes releasing the UAV from the docking station through a UAV controllable release mechanism, the docking station having a wall or ceiling mount that is arranged to mount the docking station to the wall or the ceiling.

32. The UAV of embodiment 31, wherein the release mechanism of the docking station includes a UAV controllable mechanical coupler to attach upon and release the UAV.

33. The UAV of embodiment 31, wherein the docking station includes an enclosure that houses and encloses the UAV prior to the deployment, and opens for the deployment of the UAV.

34. The UAV of embodiment 31, wherein the docking station includes one or more permanent magnets that generates an attractive force to attach the UAV to the docking station.

35. The UAV of embodiment 34, wherein the one or more permanent magnets are also electrical contacts that connect an energy storage system of the UAV to an electrical energy source to charge the UAV.

36. The UAV of embodiment 35, wherein the release mechanism of the docking station includes a UAV energizable coil that, when electrically energized, creates a magnetic field that opposes the attractive force of the one or more permanent magnets and causes a release of the UAV from the docking station.

37. A system for responding to a shooter, comprising:

a plurality of unmanned air vehicles (UAVS), each of the UAVs having

a plurality of microphones, each of the microphones generating a respective microphone signal; and

a controller having one or more processors, configured to perform operations, the operations including

detecting a gunshot sound using one or more of the plurality of microphone signals,

in response to the gunshot sound being detected,

determining a location or direction of the gunshot sound, based on two or more of the plurality of microphone signals, and

deploying the UAV to navigate to the location or the direction of the gunshot sound.

38. The system of embodiment 37, wherein the operations include

communicating, through a transceiver of the UAV, to a second UAV of the plurality of UAVs that the gunshot sound is detected, and

communicating with all of the plurality of UAVs a request causing deployment of all the plurality of UAVs to navigate to the location or the direction of the gunshot sound, only if a communication from the second UAV is received over the transceiver that confirms that the gunshot sound is also detected by the second UAV.

39. The system of embodiment 38, further comprising a plurality of docking stations dispersed throughout a facility, wherein

each UAV rests in a respective docking station prior to deployment,

deploying the UAVs to navigate to the location of the gunshot sound includes releasing the UAV from the docking station through a UAV controllable release mechanism, and

each docking station has a wall or ceiling mount that is arranged to mount the respective docking station to the wall or the ceiling.

40. The UAV of embodiment 39, wherein the release mechanism of one or more of the docking stations includes a UAV controllable mechanical coupler to attach upon and release the UAV.

41. The UAV of embodiment 39, wherein one or more of the docking stations includes an enclosure that houses and encloses the UAV prior to the deployment, and opens for the deployment of the UAV.

42. The UAV of embodiment 39, wherein one or more of the docking station includes one or more permanent magnets that generates an attractive force to attach the respective UAV to the respective docking station.

43. The UAV of embodiment 42, wherein the one or more permanent magnets are also electrical contacts that connect an energy storage system of the attached UAV to an electrical energy source, to charge the attached UAV.

44. The UAV of embodiment 42, wherein the release mechanism of one or more of the docking stations includes a UAV controllable coil that, when electrically energized, creates a magnetic field that opposes the attractive force of the one or more permanent magnets and causes a release of the UAV from the docking station.

45. The system of embodiment 37, further comprising one or more unmanned ground vehicles (UGVs), each UGV having a communication transceiver; a propulsion system that includes at least one of: a wheel, or a track; and a UGV controller having one or more processors, configured opening a window or a door.

46. The system of embodiment 36, wherein each UGV controller of a respective UGV maintains communication with the plurality of UAVs to share location data of the one or more UGVs and the plurality of UAVs.

47. The system of embodiment 46, wherein

each UGV includes at least one of a GPS receiver, a Wi-Fi receiver, an inertial navigation unit (INU), or a camera,

the one or more processors of each UGV controller is configured to navigate the UGV based on at least one of GPS data, map data, camera data, performing dead reckoning with the map data and the INU, and issuing one or more control commands to the propulsion system to move the UGV, and

the opening of the window or the door is performed in response to an indication by one or more of the plurality of UAVs of a location of the window or the door that requires opening.

48. The system of embodiment 46, wherein all of the plurality of UAVs are deployed to navigate to the location or the direction of the gunshot sound when two of more the plurality of UAVs mutually identify the gunshot sound.

49. The system of embodiment 48, wherein mutual identification of the gunshot sounds is performed through confirming between the plurality of UAVs the identification of the gunshot sound within a common time period, to confirm that the plurality of UAVs have identified a common gunshot sound.

50. The system of embodiment 49, wherein the mutual identification of the common gunshot sounds is further confirmed through identifying the common gunshot at a common location or direction by sharing a location or direction determined at each of the plurality of UAVs between the plurality of UAVs.

51. An unmanned air vehicle (UAV) comprising:

a plurality of microphones, each of the microphones generating a respective microphone signal; and a controller having one or more processors, configured to determine a location of a gunshot sound based on a location of the UAV, a time of arrival of a gunshot sound identified in any of the microphone signals, loudness of the gunshot sound, and direction of the gunshot sound as determined by the UAV, and as reported by one or more other UAVs, and deploy the UAV to navigate to the location of the gunshot sound.

52. An unmanned air vehicle (UAV) comprising:

a plurality of microphones, each of the microphones generating a respective microphone signal; and a controller having one or more processors, configured to perform operations including: for each gunshot it has identified that is detected in any of the microphone signals, broadcast to all other UAVs, a) a location of the UAV, b) a time of arrival of a gunshot sound as detected in the microphone signals of the UAV arrival, c) a direction vector from the UAV toward the gunshot sound, and d) a sound pressure level of the gunshot sound, the broadcast being used by the other UAVs to determine a location of the gunshot sound.

53. A computer, connected to a communication network, configured to perform the following: record all communications between a) UAVs, and b) between Responders and UAVs; and provide the recordings or data related to the recordings to other devices through the communication network.

54. A docking station for a UAV, comprising:

a housing, wherein when the UAV is docked in the housing, the housing conceals the UAV from view, and covers and protects the UAV from physical damage

55. The docking station of embodiment 54, wherein the housing and is transparent to sound so that the UAV can effectively monitor for gunshot sounds with one or more microphones.

56. The docking station of embodiment 55, wherein the housing has one or more cloth surfaces that allow sound to pass from outside the housing to the UAV.

57. The docking station of embodiment 54, wherein the UAV is configured to effect an opening of the housing.

58. The docking station of embodiment 54, wherein the UAV is configured to effect a release of the UAV from the housing.

59. The docking station of embodiment 54, wherein the docking station has a wall or ceiling mount that is arranged to mount the docking station to the wall, or a pole or the ceiling.

While certain aspects have been described and shown in the accompanying drawings, it is to be understood that such aspects are merely illustrative of and not restrictive, and the disclosure is not limited to the specific constructions and arrangements shown and described, since various other modifications may occur to those of ordinary skill in the art.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

In some aspects, this disclosure may include the language, for example, “at least one of [element A] and [element B].” This language may refer to one or more of the elements. For example, “at least one of A and B” may refer to “A,” “B,” or “A and B.” Specifically, “at least one of A and B” may refer to “at least one of A and at least one of B,” or “at least of either A or B.” In some aspects, this disclosure may include the language, for example, “[element A], [element B], and/or [element C].” This language may refer to either of the elements or any combination thereof. For instance, “A, B, and/or C” may refer to “A,” “B,” “C,” “A and B,” “A and C,” “B and C,” or “A, B, and C.”

What is claimed is:

1. An unmanned air vehicle (UAV) comprising:
a plurality of microphones, each generating a respective microphone signal; and
a controller having one or more processors, configured to
detect a sound of a gunshot using one or more of the plurality of microphone signals,
in response to the sound of the gunshot being detected,
determine a location or direction of the gunshot, based on the relative time of arrival of the sound of the gunshot in two or more of the plurality of microphone signals, and
deploy the UAV to navigate to the location or the direction of the gunshot.

2. The UAV of claim 1, wherein the controller is further configured to
communicate, through a transceiver of the UAV, with a second UAV that the sound of the gunshot is detected, and
deploy the UAV to navigate to the location or the direction of the gunshot in response to receiving a communication from the second UAV over the transceiver that confirms that the sound of the gunshot is also detected by the second UAV, wherein the communication from the second UAV provides information that is used by the UAV to determine the location of the gunshot.

3. The UAV of claim 1, wherein the controller is further configured to allow a user to establish two-way audio communication through the plurality of microphones and one or more loudspeakers of the UAV, or one-way video communication through a camera of the UAV.

4. The UAV of claim 1, wherein the controller is further configured to
receive a communication from a third UAV through a transceiver of the UAV, the communication indicating that the third UAV has identified the gunshot,
in response to receiving the communication from the third UAV, detect whether a sound of the gunshot is present within the plurality of microphone signals of the UAV, and
communicate to the third UAV, through the transceiver, whether the gunshot is detected by the UAV, wherein the communication from the third UAV to the UAV includes a location or a direction of the gunshot as detected by the third UAV, and the communication from the UAV to the third UAV includes a location or a direction of the gunshot as detected by the UAV.

5. The UAV of claim 1, further comprising a camera; and a paintball gun, wherein the controller is further configured to detect a shooter by using computer vision to process images output by the camera, and command the paintball gun to fire a paintball pellet at the detected shooter, the paintball pellet contains at least one of: a paint, a pungent scented material, a pungent scented paint, a pungent scented marking dye, a pungent scented pepper spray.

6. The UAV of claim 1, further comprising a camera; and a noise generator or a bright light, wherein the controller is further configured to detect a shooter by using computer vision to process images output by the camera, and activate the noise generator or the bright light when within a threshold proximity to the detected shooter.

7. The UAV of claim 1, further comprising a camera; and a magnet or grasper, wherein the controller is further configured to detect a shooter by using computer vision to process images output by the camera, and navigate the UAV to attach the UAV to a firearm held by the shooter through the magnet or the grasper.

8. The UAV of claim 7, further comprising and adhesive dispenser; and the controller is further configured to command the adhesive dispenser to dispense an adhesive onto the firearm or into an action of the firearm, upon being attached to the firearm.

9. The UAV of claim 1, wherein the UAV rests in a docking station prior to deployment and the controller is configured to deploy the UAV to navigate to the location of the gunshot including commanding a coupler to release the UAV from the docking station.

10. The UAV of claim 9, wherein the coupler attaches upon a stem of the UAV, and the coupler includes one or more electrical contacts that charge a battery of the UAV.

11. The UAV of claim 10, wherein the docking station includes a sound transparent enclosure that houses and encloses the UAV prior to the deployment, and is controllable by the UAV to open for the deployment of the UAV.

12. A system for responding to a shooter, comprising:
a plurality of unmanned air vehicles (UAVS), each having
a plurality of microphones, each of the microphones generating a respective microphone signal; and
a controller having one or more processors, configured to
detect a sound of a gunshot using one or more of the plurality of microphone signals,
in response to the sound of the gunshot being detected,
determine a location or direction of the gunshot, based on the relative time of arrival of the sound of the gunshot in two or more of the plurality of microphone signals, and
deploy to navigate to the location or the direction of the gunshot.

13. The system of claim 12, wherein the controller of each of the plurality of UAVs is further configured to
communicate, through a transceiver of the respective UAV, to a second UAV of the plurality of UAVs that the sound of the gunshot is detected, and
communicate with all of the plurality of UAVs a request causing deployment of all the plurality of UAVs to navigate to the location or the direction of the gunshot, in response to receiving a communication from the second UAV over the transceiver that confirms that the sound of the gunshot is also detected by the second UAV.

14. The system of claim 13, wherein confirmation of the sound of the gunshot is performed based on detection of the sound of the gunshot by the respective UAV and the second UAV within a common time period, to confirm that the respective UAV and the second UAV have detected a common gunshot sound.

15. The system of claim 12, wherein a networked computing system is configured to store, in a log, communications from the plurality of UAVs;
communicate a notification to one or more users in response to a detected gunshot or a tactical response of the plurality of UAVs, and
route two-way audio or visual communication between the one or more users and one or more of the plurality of UAVs.

16. The system of claim 12, further comprising a plurality of docking stations dispersed throughout a region, wherein
each UAV rests in a respective docking station prior to a deployment of the respective UAV,
deploying the plurality of UAVs to navigate to the location of the gunshot includes each of the plurality of UAVs commanding a release from the docking station through a UAV controllable coupler.

17. The system of claim 16, wherein each coupler attaches upon a stem of a respective one of the plurality of UAVs, and the coupler includes one or more electrical contacts that charge a battery of the respective one of the plurality of UAVs.

18. A docking station for a UAV, comprising:
a housing with one or more walls that visually conceals the UAV from view outside of the housing;
a UAV controllable actuator that is arranged to open the housing in response to a command from the UAV, such that the UAV can exit the docking station.

19. The docking station of claim 18, wherein the one or more walls of the housing include one or more of: or one or more openings, a cloth or perforated surface that allows sound to pass, one or more microphones that generate respective microphone signals that are passed the UAV for audio processing.

20. The docking station of claim 18, further comprising a UAV controllable coupler that attaches to and holds a UAV fixed in the docking station, the coupler including one or more electrical contacts that charge a battery of the UAV, wherein upon the command from the UAV, the coupler releases the UAV.
